(19) United States
(12) Patent Application Publication
(10) Pub. No.: US 2016/0059393 A1
(43) Pub. Date: Mar. 3, 2016

(54) ADJUSTABLE WRENCH

(71) Applicant: Shwu-Ruu Chern, Taichung (TW)

(72) Inventor: Shwu-Ruu Chern, Taichung (TW)

(21) Appl. No.: 14/474,257

(22) Filed: Sep. 1, 2014

(51) Int. Cl. B25B 23/00; B25B 13/48; B25B 13/14

(52) U.S. Cl. CPC B25B 23/0028; B25B 13/14; B25B 13/481

(57) ABSTRACT

An adjustable wrench includes a handle and a head is connected to handle. The head has a space defined therethrough and a path is defined in one end of the head. A fixed jaw extends from the head and located at one end of the path. A worm rod is rotatably located in the space. A threaded rod is movably inserted into the path and engaged with the worm rod. A movable jaw is movably connected to a protrusion extending from the threaded rod. The movable jaw has an elongate hole and a resilient member is located in the elongate hole. A pivotal member extends through the protrusion and the elongate hole. The resilient member is biased between the inner end of the elongate hole and the pivotal member. The movable jaw is loosened from the object by reversely rotating the handle of the wrench.

### BACKGROUND OF THE INVENTION

1. Fields of the Invention

The present invention relates to an adjustable wrench, and more particularly, to an adjustable wrench that is able to rotate the object continuously without being separated from the object.

2. Descriptions of Related Art

The conventional adjustable wrench comprises a handle with a head connected to one end of the handle, and the head has a fixed jaw and a movable jaw is connected to the head and located corresponding to the fixed jaw. An object such as a nut is clamped between the fixed jaw and the movable jaw. The movable jaw has a threaded rod which is threadedly engaged with a worm rod in the head. The user rotates the worm rod to drive the threaded rod of the movable jaw to adjust the distance between the fixed jaw and the movable jaw.

The nut is clamped between the fixed jaw and the movable jaw, the user rotates the handle to tighten or loosen the nut. However, when using the adjustable wrench, especially when the nut is located in a narrow space, the handle is too long to rotate within the narrow space, the user has to operate the movable jaw repeatedly to separate the wrench from the object, and adjust the angle of the wrench and to clamp the object again. This takes a lot of time and significantly reduces efficiency. Besides, the face of the head is parallel to the face of the head, so that the handle of the wrench has to be located at a position that is located at the same plane of the object. When the nut is located in a recessed area, the wrench can only clamp a portion of the nut and is easily separated from the nut when operating the wrench.

The present invention intends to provide an adjustable wrench which eliminates the shortcomings mentioned above.

### SUMMARY OF THE INVENTION

The present invention relates to an adjustable wrench and comprises a handle and a head has the first end thereof connected to the first end of the handle, and the head has a space defined therethrough. A path is defined in the second end of the head. A fixed jaw extends from the head and is located at one end of the path. The fixed jaw has a first clamping portion defined in the inside thereof. A worm rod is rotatably located in the space by extending a pin through the head and the worm rod. A movable jaw unit comprises a threaded rod having a protrusion, a movable jaw, a resilient member and a pivotal member. The threaded rod is movably inserted into the path and engaged with the worm rod. The movable jaw is movably connected to the protrusion of the threaded rod. The movable jaw has a second clamping portion which faces the first clamping portion. The movable jaw has an elongate hole and the resilient member is located in the elongate hole. The pivotal member extends through the protrusion and the elongate hole. The resilient member is biased between the inner end of the elongate hole and the pivotal member.

Preferably, the resilient member is a spring.

Preferably, the protrusion has a slot and the movable jaw has an insertion through which the elongate hole is defined. The insertion is inserted in the slot.

Preferably, the slot communicates with an enlarged path in the protrusion. The insertion has an enlarged ridge which is slidably engaged with the enlarged path.

Preferably, the first and second clamping portions each have a V-shaped face.

Preferably, the handle and the head are integrally formed to each other.

Preferably, the handle and the head are two individual parts.

Preferably, the handle has two lugs extending from the first end thereof and each lug has a through hole. The head has an extension and multiple positioning grooves are defined in the outside of the extension. The extension is pivotably connected between the two lugs by extending a pin through the two through holes and the extension. An adjustment unit is connected to the handle and has a contact member, a resilient member and a push rod. A positioning hole is defined in the first end of the handle and located between the two lugs. The contact member is located in the positioning hole and engaged with one of the positioning grooves. A passage is defined in the first end of the handle and communicates with the positioning hole. The resilient member and the push rod of the adjustment unit are located in the passage. The push rod has a notch and the contact member is optionally received in the notch.

Preferably, the contact member is a bead.

Preferably, the resilient member of the adjustment unit is a spring.

The primary object of the present invention is to provide an adjustable wrench which can be easily operated in a narrow space.

Another object of the present invention is to provide an adjustable wrench wherein the head is pivotable relative to the handle.

Yet another object of the present invention is to provide an adjustable wrench wherein the movable jaw is automatically loosened from the object when reversely operating the handle.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the adjustable wrench of the present invention;

FIG. 2 is an exploded view of the adjustable wrench of the present invention;

FIG. 3 is a cross sectional view to show that the adjustable wrench of the present invention clamps a nut and rotated clockwise;

FIG. 4 is a cross sectional view to show that the movable jaw is moved to temporarily release the nut when the adjustable wrench of the present invention is rotated counter clockwise;

FIG. 5 shows that the head the adjustable wrench of the present invention is pivoted an angle when pushing the push rod;

FIG. 6 shows the cross sectional view of the action disclosed in FIG. 5;

FIG. 7 is a cross sectional view to show that the contact member is engaged with the positioning groove of the extension of the head;

FIG. 8 is a cross sectional view to show a pipe is clamped by the adjustable wrench of the present invention and the handle is rotated clockwise, and

FIG. 9 is a cross sectional view to show that the movable jaw is moved to temporarily release the pipe when the adjustable wrench of the present invention is rotated counter clockwise.

### DETAILED DESCRIPTION OF THE PREFERRED EMBODIMENT

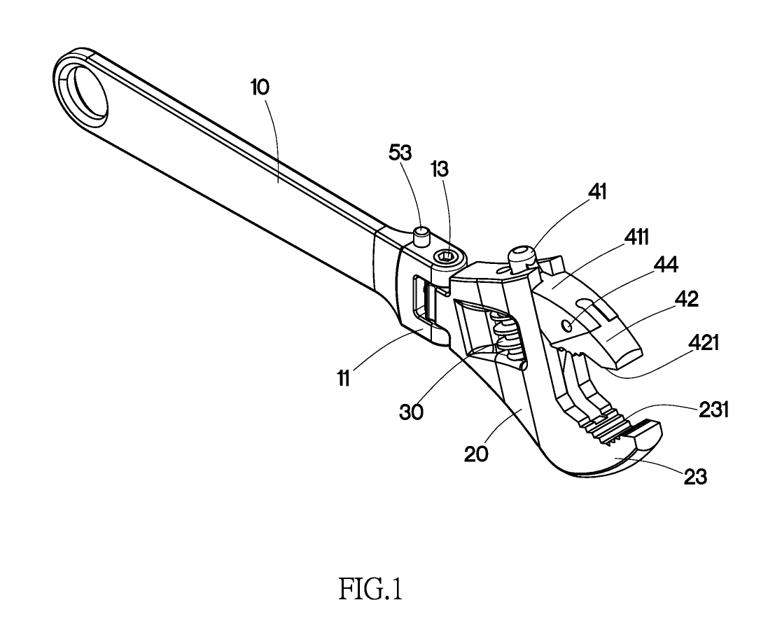

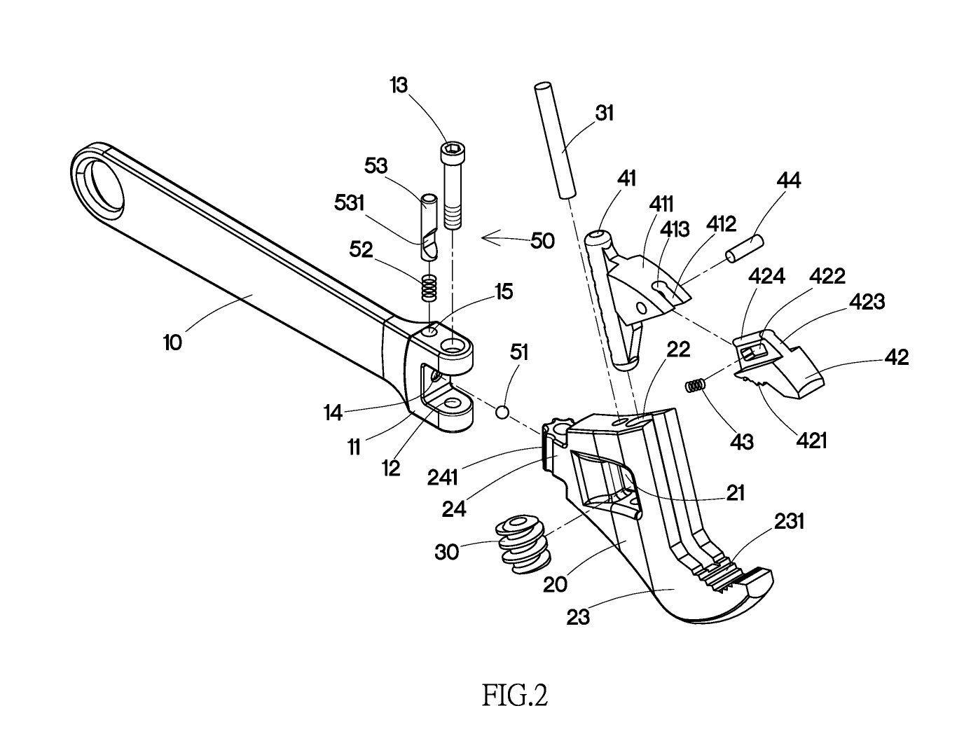

Referring to FIGS. 1 to 7, the adjustable wrench of the present invention comprises a handle 10 and two lugs 11 extend from the first end of the handle 10, and each lug 11 has a through hole 12.

A head 20 has an extension 24 on the first end thereof and multiple positioning grooves 241 are defined in the outside of the extension 24. The extension 24 is pivotably connected between the two lugs 11 by extending a pin 13 through the two through holes 12 and the extension 24. A space 21 is defined through the head 20 and a path 22 is defined in the second end of the head 20. A fixed jaw 23 extends from the head 20 and is located at one end of the path 22. The fixed jaw 23 has a first clamping portion 231 defined in the inside thereof. A worm rod 30 is rotatably located in the space 21 by extending a pin 31 through the head 20 and the worm rod 30.

A movable jaw unit 40 has threaded rod 41, a protrusion 411, a movable jaw 42, a resilient member 43 and a pivotal member 44. The threaded rod 41 is movably inserted into the path 22 and engaged with the worm rod 30. The movable jaw 42 is movably connected to the protrusion 411 of the threaded rod 41. The movable jaw 42 has a second clamping portion 421 which faces the first clamping portion 231. The first and second clamping portions 231, 421 each have a V-shaped face which has teeth formed therein. The handle 10 and the head 20 can be integrally formed to each other, or the handle 10 and the head 20 are two individual parts.

The movable jaw 42 has an elongate hole 422 and the resilient member 43 is located in the elongate hole 422. The pivotal member 44 extends through the protrusion 411 and the elongate hole 422. The resilient member 43 is biased between one inner end of the elongate hole 422 and the pivotal member 44. In this embodiment, the resilient member 43 is a spring.

The protrusion 411 has a slot 412, and the movable jaw 42 has an insertion 423 through which the elongate hole 422 is defined. The insertion 423 is inserted in the slot 412. In detail, the slot 412 communicates with an enlarged path 413 in the protrusion 411, and the insertion 423 has an enlarged ridge 424 which is slidably engaged with the enlarged path 413.

An adjustment unit 50 is connected to the handle 10 and has a contact member 51, a resilient member 52 and a push rod 53. A positioning hole 14 is defined in the first end of the handle 10 and located between the two lugs 11. The contact member 51, such as a bead, is located in the positioning hole 14 and engaged with one of the positioning grooves 241. A passage 15 is defined in the first end of the handle 10 and communicates with the positioning hole 14. The resilient member 52 and the push rod 53 of the adjustment unit 50 are located in the passage 15. The push rod 53 has a notch 531 and the contact member 51 is optionally received in the notch 531. In this embodiment, the resilient member 52 of the adjustment unit 50 is a spring.

When clamping a hexagonal nut 60 between the fixed jaw 23 and the movable jaw 42, the user rotates the worm rod 30 to rotate the threaded rod 41 so that the movable jaw 42 moves toward the nut 60 until the nut 60 is clamped by the first and second clamping portions 231, 421. By rotating the handle 10, the nut 60 is tightened or loosened.

Because there are teeth formed in the first and second clamping portions 231, 421, the nut or other object with smooth surface can be clamped securely.

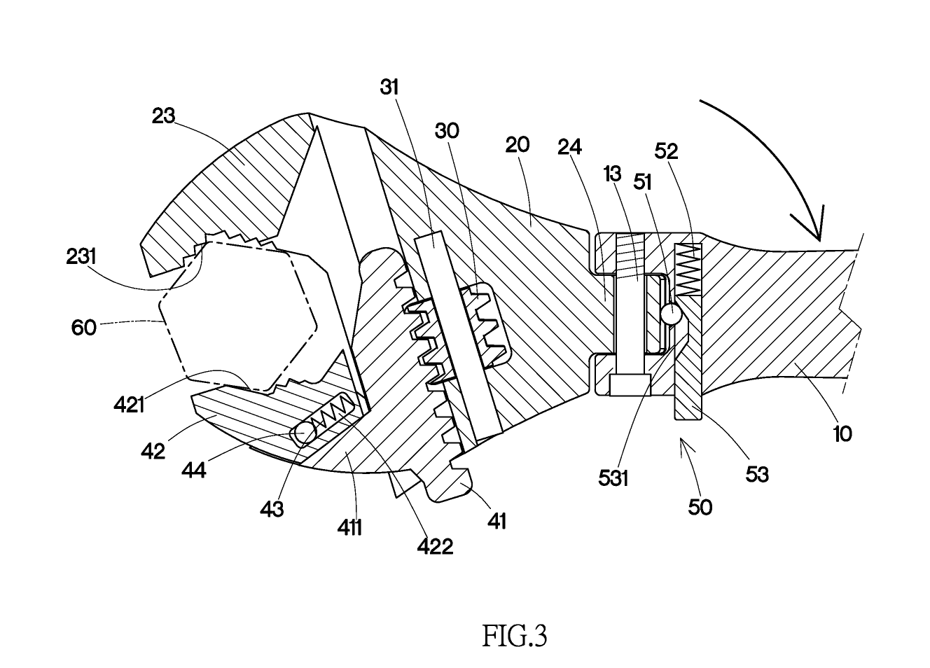

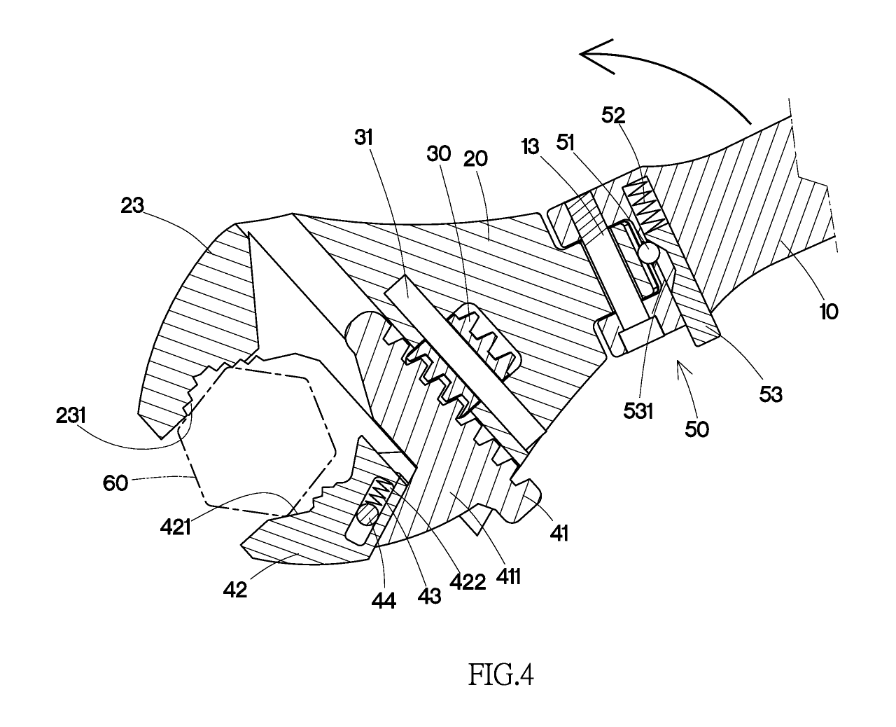

As shown in FIG. 3, after the nut 60 is tightened, the handle 10 can be directly rotated reversely without removing the head 20 from the nut 60. When the handle 10 is rotated counter clockwise as shown in FIG. 4, the resilient member 43 is compressed and the movable jaw 42 is temporarily loosened from the nut 60, the head 20 is then rotated to another position relative to the nut 60, the resilient member 43 is released and the movable jaw 42 clamps the nut 60 again. This allows the adjustable wrench of the present invention to be operated as a ratchet wrench.

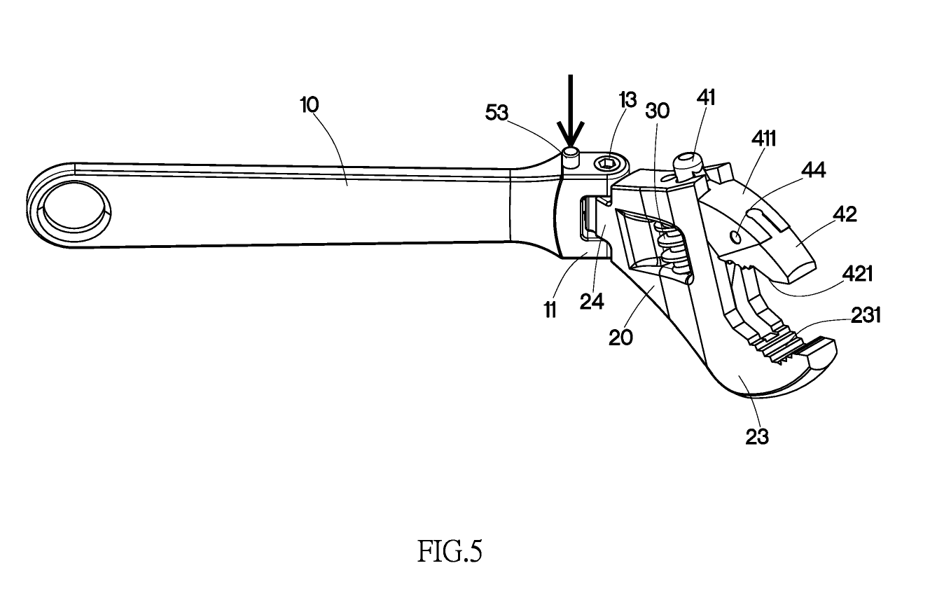

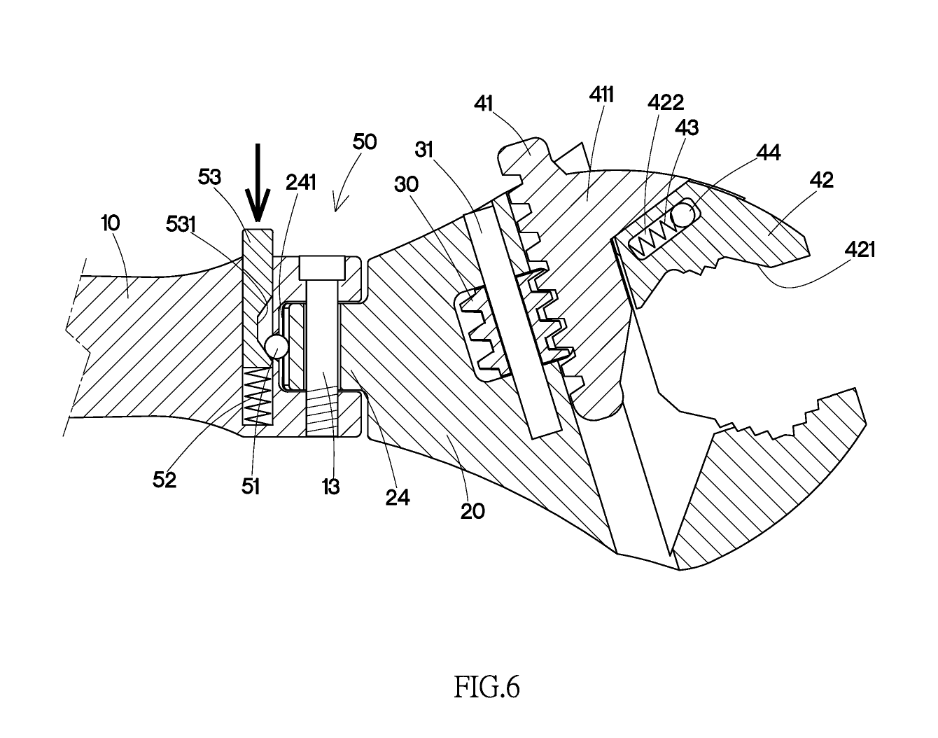

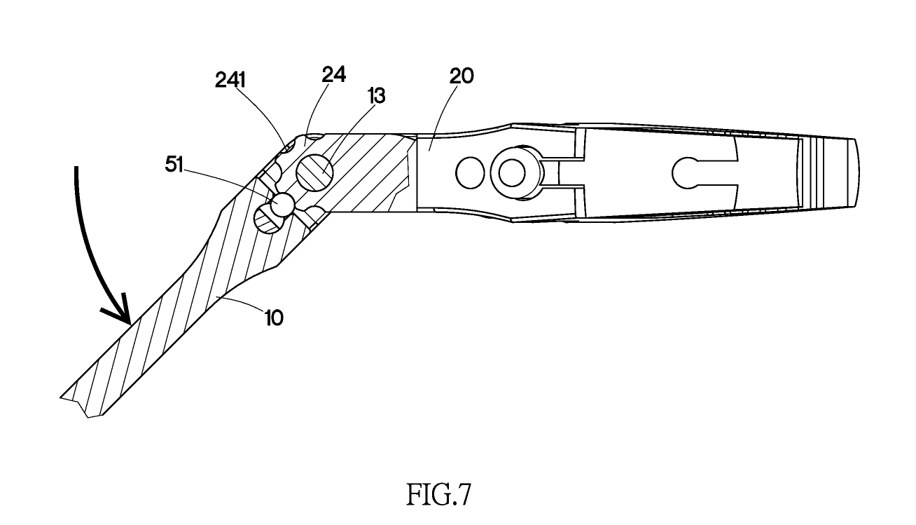

When adjusting the angle of the head 20 relative to the handle 10, the push rod 53 is pushed downward as shown in FIGS. 5 and 6, the resilient member 52 is compressed and the contact member 51 is engaged with the notch 531 of the push rod 53 so that the handle 10 is pivoted about the pin 13 to another position. When the push rod 53 is released, the resilient member 52 pushes the push rod 53 upward, and the contact member 51 is pushed outward by the inside of the notch 531 so that the contact member 51 is engaged with one of the positioning grooves 241 of the extension 24 as shown in FIG. 7. The handle 10 is positioned at the new position.

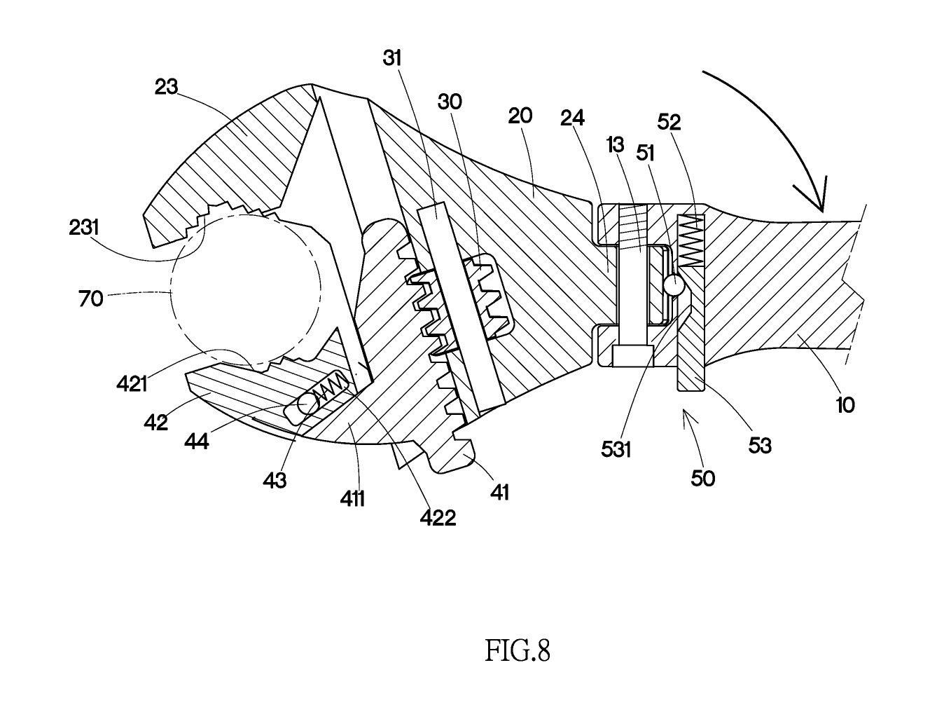

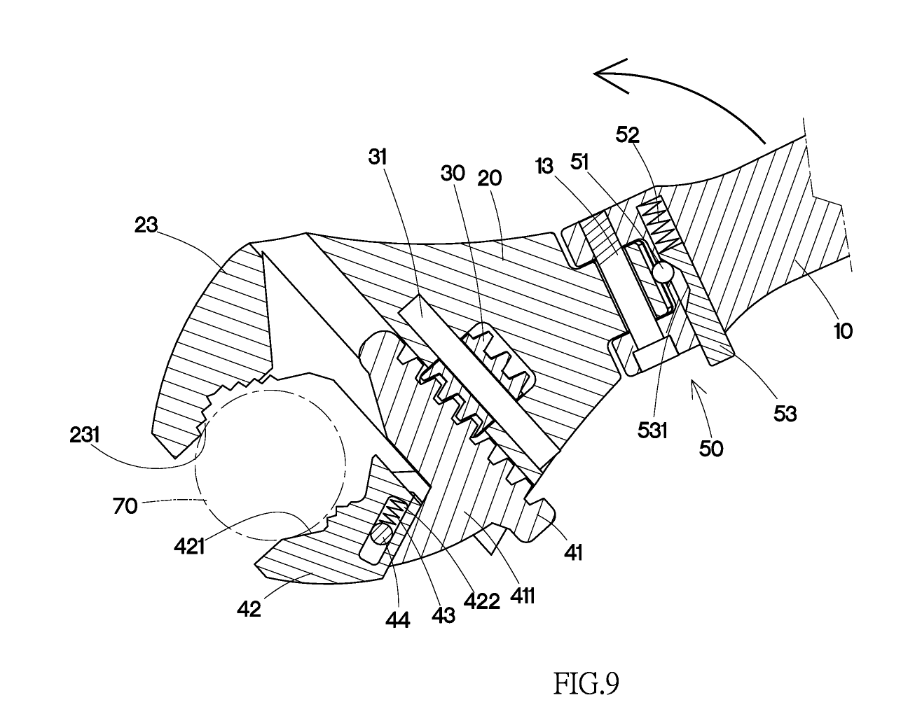

As shown in FIGS. 8 and 9, the adjustable wrench can also be used to clamp a pipe 70. When the handle 10 is rotated clockwise as shown in FIG. 8 to tighten the pipe 70, the user can immediately rotate the handle counter clockwise as shown in FIG. 9, the resilient member 43 is compressed and the movable jaw 42 is then released. The head 20 is rotated to another position. When the resilient member 43 is released, the movable jaw 42 clamps the pipe 70 again.

The present invention allows the user to rotate the nut 60 or the pipe 70 back and forth without removing the head 20 away from the nut 60 or the pipe 70. This increases the efficiency of the work. The head 20 is pivotable relative to the handle 10 so as to access the object in a narrow space or deep position.

While we have shown and described the embodiment in accordance with the present invention, it should be clear to those skilled in the art that further embodiments may be made without departing from the scope of the present invention.

What is claimed is:

1. An adjustable wrench comprising:
a handle;
a head having a first end connected to a first end of the handle and having a space defined through the head, a path defined in a second end of the head, a fixed jaw extending from the head and located at an end of the path, the fixed jaw having a first clamping portion defined in an inside thereof;
a worm rod rotatably located in the space by extending a pin through the head and the worm rod, and
a movable jaw unit having threaded rod having a protrusion, a movable jaw, a resilient member and a pivotal member, the threaded rod movably inserted into the path and engaged with the worm rod, the movable jaw movably connected to the protrusion of the threaded rod, the movable jaw having a second clamping portion which faces the first clamping portion, the movable jaw having an elongate hole and the resilient member located in the elongate hole, the pivotal member extending through the protrusion and the elongate hole, the resilient member being biased between an inner end of the elongate hole and the pivotal member.

2. The wrench as claimed in claim 1, wherein the resilient member is a spring.

3. The wrench as claimed in claim 1, wherein the protrusion has a slot, the movable jaw has an insertion through which the elongate hole is defined, the insertion is inserted in the slot.

4. The wrench as claimed in claim 3, wherein the slot communicates with an enlarged path in the protrusion, the insertion has an enlarged ridge which is slidably engaged with the enlarged path.

5. The wrench as claimed in claim 1, wherein the first and second clamping portions each have a V-shaped face.

6. The wrench as claimed in claim 1, wherein the handle and the head are integrally formed to each other.

7. The wrench as claimed in claim 1, wherein the handle and the head are two individual parts.

8. The wrench as claimed in claim 7, wherein the handle has two lugs extending from the first end thereof and each lug has a through hole, the head has an extension and multiple positioning grooves are defined in an outside of the extension, the extension is pivotably connected between the two lugs by extending a pin through the two through holes and the extension, an adjustment unit is connected to the handle and has a contact member, a resilient member and a push rod, a positioning hole is defined in the first end of the handle and located between the two lugs, the contact member is located in the positioning hole and engaged with one of the positioning grooves, a passage is defined in the first end of the handle and communicates with the positioning hole, the resilient member and the push rod of the adjustment unit are located in the passage, the push rod has a notch and the contact member is optionally received in the notch.

9. The wrench as claimed in claim 8, wherein the contact member is a bead.

10. The wrench as claimed in claim 8, wherein the resilient member of the adjustment unit is a spring.
